(19) United States
(12) Patent Application Publication
(10) Pub. No.: US 2013/0298640 A1
(43) Pub. Date: Nov. 14, 2013

(54) METHOD FOR OPERATING A SOOT SENSOR

(71) Applicants: Johannes Ante, Regensburg (DE); Philippe Grass, Regensburg (DE); Markus Herrmann, Regensburg (DE); Willibald Reitmeier, Hohenschambach (DE); Denny Schädlich, Neustadt (DE); Manfred Weigl, Sinzing/Viehhausen (DE); Andreas Wildgen, Nittendorf (DE)

(72) Inventors: Johannes Ante, Regensburg (DE); Philippe Grass, Regensburg (DE); Markus Herrmann, Regensburg (DE); Willibald Reitmeier, Hohenschambach (DE); Denny Schädlich, Neustadt (DE); Manfred Weigl, Sinzing/Viehhausen (DE); Andreas Wildgen, Nittendorf (DE)

(73) Assignee: CONTINENTAL AUTOMOTIVE GmbH, Hannover (DE)

(21) Appl. No.: 13/997,165

(22) PCT Filed: Dec. 21, 2011
(86) PCT No.: PCT/EP2011/073517

§ 371 Date: Jun. 21, 2013

(30) Foreign Application Priority Data
Dec. 22, 2010 (DE) 10 2010 055 478.2

(51) Int. Cl. G01N 15/06

(52) U.S. Cl. CPC G01N 15/0656
USPC 73/28.01

(57) ABSTRACT

A method for operating a soot sensor that has an interdigital electrode structure, to which a measurement voltage is applied. Soot particles from an exhaust gas flow are deposited onto the interdigital electrode structure and the measurement current is evaluated as a measure of the soot load of the soot sensor. The interdigital electrode structure is burned clean at or above a predetermined soot load, which is detected by means of an upper current threshold. The method includes burning the interdigital electrode structure clean by heating up the soot sensor after the upper current threshold has been reached; monitoring the measurement current while the interdigital electrode structure is being burned clean; and stopping the burning clean when the value of the measurement current has reached a lower current threshold.

### CROSS REFERENCE TO RELATED APPLICATION

This is a U.S. national stage of application No. PCT/EP2011/073517, filed on Dec. 21, 2011. Priority is claimed on German Application No. DE 10 2010 055 478.2 filed Dec. 22, 2010, the content of which is incorporated here by reference.

### BACKGROUND OF THE INVENTION

1. Field of the Invention

The invention relates to a method for operating a carbon particulate sensor, wherein the carbon particulate sensor comprises an interleaved finger electrode structure to which a measuring voltage is applied, wherein carbon particulates from an exhaust gas flow are deposited on the interleaved finger electrode structure and the measuring current that flows over the carbon particulates and the interleaved finger electrode structure is evaluated as a measurement for the carbon particulate concentration on the carbon particulate sensor and wherein the interleaved finger electrode structure is burned clean if the carbon particulate concentration that is detected by an upper current threshold exceeds a predetermined value.

2. Description of the Prior Art

The increased concentration in the atmosphere of pollutants from exhaust gases is currently frequently discussed. These discussions are associated with the fact that the availability of fossil energy carriers is limited. In response thereto, for example, combustion processes in internal combustion engines are thermo-dynamically optimized so that their efficiency level is improved. This is reflected in the automobile field in the increasing use of diesel engines. However, the disadvantage of this combustion engineering in comparison to optimized Otto engines is a considerably higher emission of carbon particulates. Carbon particulates can be extremely carcinogenic particularly as a result of the concentration of polycyclic aromatic hydrocarbons and various regulations have already been introduced in response to this. Thus, for example, exhaust gas emission standards that dictate maximum limits for the carbon particulate emission have been issued. It has therefore become necessary to provide cost-effective sensors that measure in a reliable manner the carbon particulate concentration in the exhaust gas flow of motor vehicles.

Carbon particulate sensors of this type are used to measure an actual amount of carbon particulates that are discharged with the exhaust gas flow so that information relating to the prevailing driving situation is available to an engine management system in an automobile to reduce the emission values by adjustments relating to control engineering. In addition, it is possible with the aid of carbon particulate sensors to initiate an active treatment of exhaust gases using exhaust gas carbon particulate filters or the exhaust gas can be returned to the internal combustion engine. The process of filtering the carbon particulates involves the use of filters that can be regenerated and that filter out a considerable part of the carbon particulate concentration from the exhaust gas. However, carbon particulate sensors are required to detect the carbon particulates to monitor the function of the carbon particulate filters and/or in order to control the regeneration cycles of said filters.

For this purpose, it is possible to connect a carbon particulate sensor upstream of the carbon particulate filter, which is also referred to as a diesel particulate filter and/or to connect a carbon particulate sensor downstream of said carbon particulate filter.

The sensor that is connected upstream of the diesel particulate filter is used to increase the safety of the system and to ensure a safe and reliable operation of the diesel particulate filter under optimum conditions. Since this depends to a great extent upon the quantity of carbon particulates that are deposited in the diesel particulate filter, it is extremely important to obtain a precise measurement of the particulate concentration upstream of the diesel particulate filter system and in particular to ascertain if there is a high carbon particulate concentration upstream of the diesel particulate filter.

A sensor that is connected downstream of the diesel particulate filter provides the ability to perform an on-board diagnosis and moreover said sensor is used to ensure the correct operation of the exhaust gas treatment system.

Various approaches for detecting carbon particulates are available in the prior art. One approach that continues to be studied in laboratories is the use of light dispersion through the carbon particulates. This method is suitable for costly measuring devices. However, when attempts are made to also use this method as a mobile sensor system in the exhaust gas tract, it has been established that approaches of this type for providing a sensor in a motor vehicle are encumbered by high costs as a result of the expensive optical structure. Furthermore, the problems relating to the necessary optical windows being contaminated by combustion gases have not yet been solved.

The unexamined German application DE 199 59 871 A1 discloses a sensor and an operating method for the sensor, wherein both the sensor and the operating method are based on thermal considerations. The sensor comprises an open porous molded body, for example a honey-combed ceramic body, a heating element, and a temperature sensor. If the sensor is brought into contact with a volume of measuring gas, the carbon particulates are deposited thereon. To perform the measurement, the carbon particulates that have been deposited over a period of time are ignited with the aid of the heating element and burned. The increase in temperature that occurs during the burning process is measured.

Particulate sensors for conductive particles are currently known, said sensors comprise two or more metal electrodes that engage one with the other in a mesh-like manner. These mesh-like structures are also described as interleaved finger structures. Carbon particulates that are deposited on these sensor structures bridge the electrodes and consequently change the impedance of the electrode structure. As the concentration of particulates on the sensor surface increases, it is possible in this manner to measure the decreasing resistance and/or an increasing current in the presence of a constant voltage between the electrodes. A carbon particulate sensor of this type is disclosed in DE 10 2004 028 997 A1. However, in order to be able to measure a current between the electrodes, a specific quantity of carbon particulates must be available between the electrodes. The carbon particulate sensor is to a certain extent blind to the carbon particulate concentration in the exhaust gas flow unless the concentration has achieved this minimum level of carbon particulate concentration. In the case of DE 10 2005 030 134 A1 the minimum particulate concentration between the electrodes is achieved by virtue of the conductive particles that are arranged in an artificial manner in the space between the electrodes. However, the technical aspect of arranging these particulates is extremely difficult and costly. In addition, it is possible during the serviceable life of the carbon particulate sensor, for example in the event of the sensor being jolted or as a result of chemical processes, for these particles to become detached as a result of which the characteristics of the sensor are changed and a reliable measurement of the carbon particulate concentration in the exhaust gas flow is disrupted or completely prevented.

In addition, the carbon particulate sensor needs to be cleaned at regular intervals. The sensor is regenerated by burning off the deposited carbon particulates. In order to regenerate the sensor element, the carbon particulates are generally burned off said sensor element with the aid of an integrated heating element after the carbon particulates have been deposited. During the burning-off phase the sensor is unable to sense the concentration of carbon particulates in the exhaust gas flow. The time required for the sensor structure to be regenerated by means of the burning-off method is also described as a down time of the sensor. It is therefore important to be able to keep the burning-off phase and the subsequent phase of reconditioning the carbon particulate sensor as short as possible, in order to be able to use the carbon particulate sensor as quickly as possible for performing further carbon particulate measurements.

### SUMMARY OF THE INVENTION

An object of one embodiment of the invention is a method for operating a carbon particulate sensor that delivers meaningful measurement results, wherein the carbon particulate sensor is to comprise as short as possible down times.

The down time of the carbon particulate sensor can be maintained extremely short by virtue of the fact that the carbon particulates are burned off the interleaved electrode structure by heating up the carbon particulate sensor after the upper current threshold is achieved, whereupon the measuring current is monitored during the process of burning off the carbon particulates from the interleaved electrode structure and the burning-off process is terminated if the value of the measuring current has achieved a lower current threshold. Furthermore, it has been demonstrated in a surprising manner that by the disclosed method a considerable linearization occurs of the current characteristic curve that is created by the carbon particulate concentration in the sensor.

By virtue of the linear relationship, created using the method in accordance with one embodiment of the invention, between the carbon particulate concentration in the sensor and its current characteristic curve, it is possible without any further calibration or introducing characteristic fields to determine in the exhaust gas flow absolute measured values for the carbon particulate loading (quantity of carbon particulates per unit volume of the exhaust gas).

The carbon particulate concentration in the exhaust gas flow of a motor vehicle can be monitored almost continuously using the method in accordance with one embodiment of the invention, as a consequence of which, it is possible to reduce considerably the emission of pollutants. In addition, the structure of the measuring electrodes of the carbon particulate sensor can be produced in a robust and cost-effective manner using thick-layer technology or on the basis of co-fired technology.

A further development of the invention is characterized in that the value for the lower current threshold is between 1% and 20% of the value for the upper current threshold. As a result, the carbon particulate sensor is ready again for use even more quickly after the carbon particulates have been burned off from the interleaved finger electrode structure. This is due to the fact that by selecting this lower current threshold there remains a sufficient part of the carbon bridges that have been formed from the carbon particulates between the interleaved finger electrodes. A measuring current is therefore available for the carbon particulate sensor immediately after a burning-off process is performed within the scope of the disclosed operating method. Time-consuming processes of reconfiguring the carbon bridges on the interleaved finger electrode structure are not required.

If the interleaved finger electrode structure comprises measuring electrodes that have a width between 50 and 100 μm, said electrode structure can be produced in a particularly robust and cost-effective manner using thick-layer technology or co-fired technology. The measured values that can be achieved using an electrode structure of this type are of sufficient accuracy for example for using the carbon particulate sensor in the exhaust gas tract of a motor vehicle.

In addition, this between 50 and 100 μm thick-layer electrode structure has a particularly long life.

If the burning-off process is performed using an electrical heating element that is heated with the aid of a heating current, the burning-off process can be easily monitored and terminated in an extremely simple and precise manner.

### BRIEF DESCRIPTION OF THE DRAWINGS

The invention is explained hereinunder in detail with reference to the following drawings, in which:

FIG. 1 illustrates a carbon particulate sensor;

FIG. 2 illustrates an operational method of the carbon particulate sensor;

FIGS. 3 to 8 illustrate a method for operating a carbon particulate sensor; and

FIG. 9 illustrates the functional relationship between the measurement current I_{M} and the time t.

### DETAILED DESCRIPTION OF THE PREFERRED EMBODIMENTS

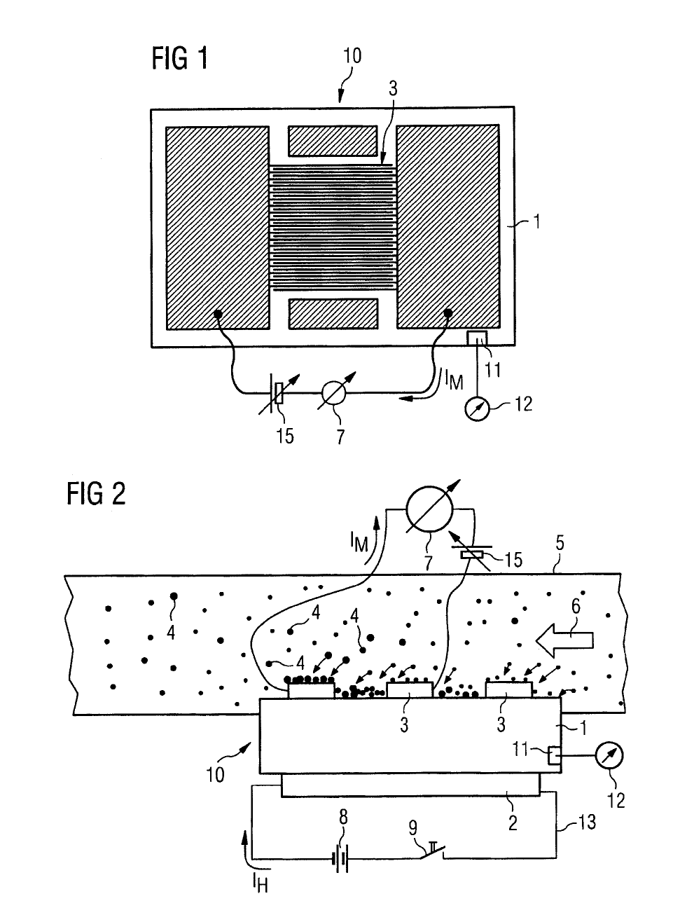

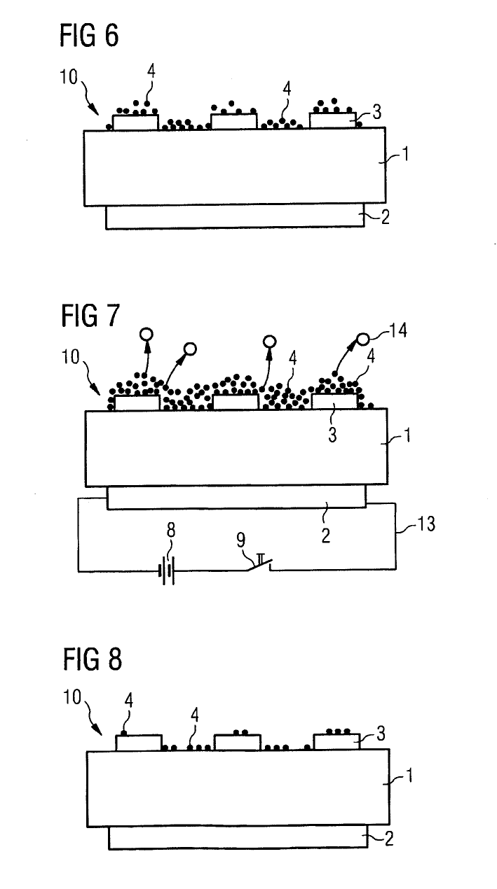

FIG. 1 illustrates a carbon particulate sensor 10 that has a molded body 1, a heating element, not represented here, and a structure of measuring electrodes 3 that engage one with the other in an interleaved finger manner. The molded body 1 can be produced from a ceramic material or can be embodied from a different material that comprises electrically insulating properties and resists the temperatures involved when burning-off carbon particulates 4. In order to burn off the carbon particulates 4 from the carbon particulate sensor 10, the carbon particulate sensor 10 is heated to temperatures between 500 and 800° C. in a typical manner with the aid of an electrical resistance heater 4. The electrically insulating molded body 1 must be able to withstand these temperatures without being damaged. The structure of the measuring electrodes 3 is embodied in this case by way of example as a mesh-like structure that is also described as an interleaved finger electrode structure wherein an electrically insulating region of the molded body 1 is always to be seen between two measuring electrodes 3. The measuring electrodes 3 and the intermediate spaces between the measuring electrodes 3 form the interleaved finger electrode structure. The width B of a measuring electrode 3 can, for example, be between 50 and 100 μm and the spacing A between the individual measuring electrodes 3 can likewise amount to between 50 and 100 μm (FIG. 3). An interleaved finger electrode structure having dimensions of this range can be easily produced using thick-layer technology. Interleaved finger electrode structures that are produced using thick-layer technology are robust, have a long serviceable life and are cost-effective.

The measuring current I_{M} between the measuring electrodes 3 is measured with the aid of a current measuring element 7. As long as the carbon particulate sensor 10 is completely free of carbon particulates 4, no measuring current I_{M} can be measured by the current measuring element 7, since there is always a region of the molded body 1 between the measuring electrodes 3, which region acts in an electrically insulating manner and is also not bridged by carbon particulates 4.

Furthermore, FIG. 1 illustrates a temperature sensor 11 as a component of the carbon particulate sensor 10 having an electronic temperature evaluating unit 12 that is used to monitor the temperature prevailing in the carbon particulate sensor 10, primarily during the process of burning off the carbon particulate deposits from the interleaved finger electrode structure 3 of the carbon particulate sensor 10.

In addition, FIG. 1 illustrates a voltage source 15 that determines the voltage that is applied to the measuring electrodes 3. Measuring voltage can be applied to the measuring electrodes 3 by the voltage source 15.

The measuring voltage can for example be between 20 and 60 volts and in a preferred embodiment can be between 40 and 60 volts.

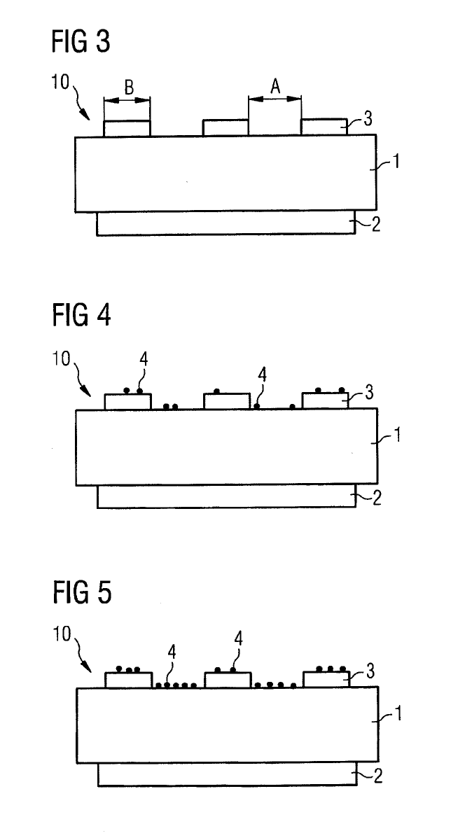

FIG. 2 illustrates the method of operation of the carbon particulate sensor 10. In this case, the carbon particulate sensor 10 is arranged in an exhaust gas pipe 5, for example of a motor vehicle, and an exhaust gas flow 6 that is laden with carbon particulates 4 is directed through said exhaust gas pipes. The flow direction of the exhaust gas flow 6 is indicated by the arrow. The carbon particulate sensor 10 now has the task of measuring the concentration of the carbon particulates 4 in the exhaust gas flow 6. For this purpose, the carbon particulate sensor 10 is provided, if necessary, with a protective cap and arranged in the exhaust gas pipe 5 such that the structure of measuring electrodes 3 arranged in an interleaved finger manner interact with the exhaust gas flow 6 and consequently with the carbon particulates 4. Carbon particulates 4 from the exhaust gas flow 6 are deposited both on the measuring electrodes 3 and also in the intermediate spaces between the measuring electrodes 3, in other words on the insulating regions of the molded body 1. If sufficient carbon particulates 4 have been deposited on the insulating regions between the measuring electrodes 3, then as a result of the measuring voltage, which is applied to the measuring electrodes 3, and the conductive properties of the carbon particulates 4, a measuring current I_{M} flows between the measuring electrodes 3 that can be measured by the current measuring element 7. The carbon particulates 4 consequently bridge the electrically insulating intermediate spaces between the measuring electrodes 3. In this manner, it is possible using the carbon particulate sensor 10, illustrated here, to measure the concentration of carbon particulates 4 in the exhaust gas flow 6.

In addition, the carbon particulate sensor 10 in FIG. 2 illustrates the heating element 2 that can be supplied with electrical heating current I_{H} from the heating current supply 8 by the heating current circuit 13. In order to heat the carbon particulate sensor 10 to the temperature required for burning off the carbon particulates 4, the heating current switch 9 is closed, as a consequence of which the heating current I_{H} heats up the heating element 2 and the entire carbon particulate sensor 10 is heated. In addition, a temperature sensor 11 is integrated in the carbon particulate sensor 10, which temperature sensor 11 with the aid of the electronic temperature evaluating unit 12 checks and monitors the process of heating up the carbon particulate sensor 10 and also the process of burning off the carbon particulates 4, which process is also referred to as burning clean the carbon particulate sensor 10.

If the process of burning off the carbon particulates 4 has progressed to a sufficient level and the carbon particulates 4 have been burned off the interleaved finger electrode structure to a great extent, it is possible to interrupt the burning-off process. The progression of the burning-off process is detected and monitored with the aid of the current measuring element 7.

If a predetermined lower current threshold value I_{U} is achieved, the heating current I_{H} is interrupted and the burning-off process is terminated. As a consequence, carbon particulates 4 that have not been burned off remain on the interleaved finger electrode structure 3 and the carbon particulates 4 that remain between the measuring elements 3 together with the carbon particulates 4 that are newly deposited from the exhaust gas flow 6 very rapidly reorganize themselves. The current paths of reorganized carbon particulates 4 between the measuring electrodes 3 cause a linearization of the current characteristic curve 16 of the carbon particulate sensor 10. As a consequence, the so-called down time of the carbon particulate sensor 10 is greatly reduced after the interleaved finger electrode structure 3 has been burned clean.

The current measuring element 7, the electronic temperature evaluating unit 12, the voltage source 15, the temperature sensor 11, and the heating current switch 9 are represented here in an exemplary manner as separate components. Naturally, these components can be provided on a chip as components of a micro-mechanical system together with the measuring electrodes or as components of a micro-electronic circuit that is integrated for example in a control device for the carbon particulate sensor 10.

FIGS. 3 to 8 explain the working cycle of the carbon particulate sensor 10. Only the carbon particulate sensor 10 is illustrated in each case in FIGS. 3 to 8, from which it is assumed that the carbon particulate sensors 10 illustrated in these figures are electrically connected in a similar manner to that shown in FIG. 1 or 2 and are arranged in an exhaust gas flow 6. The measuring current I_{M} is monitored using a current measuring element 7 that is connected in a similar manner to that shown in FIGS. 1 and 2.

FIG. 3 illustrates an unused, new from the factory, carbon particulate sensor 10. The molded body 1, the heating element 2 and the structure comprising the measuring electrodes 3, which are also described as the interleaved finger electrode structure 3, are evident. The width B of one measuring electrode 3 can be between 50 and 100 μm and the spacing A between the individual measuring electrodes 3 can likewise be 50 and 100 μm. There are no carbon particulates 4 on the measuring electrodes 3 and in the intermediate spaces between the measuring electrodes 3. As a result, measuring current I_{M} cannot flow between the electrodes 3 and consequently it would not be possible to obtain a measured value on the current measuring element 7.

In FIG. 4, the carbon particulate sensor 10 has been exposed to a particular exhaust gas flow 6 and the carbon particulates 4 have been deposited both on the measuring electrodes 3 and also in the intermediate spaces between the measuring electrodes 3. However, the number of carbon particulates 4 between the measuring electrodes 3 is still so small that it is not possible for any measurable measuring current I_{M} to flow between the measuring electrodes 3 and therefore there is also no measured value available at the current measuring element 7. The extent here to which the carbon particulates 4 bridge the insulating intermediate spaces between the measuring electrodes 3 is still not sufficient to allow the flow of an electrical measuring current I_{M}. In this situation, the carbon particulate sensor 10 is blind to the carbon particulate concentration in the exhaust gas flow 6.

A first response of the carbon particulate sensor 10 is to be expected in the situation illustrated in FIG. 5. The measuring voltage, as already illustrated in FIGS. 3 and 4, is applied between the measuring electrodes 3 and at this stage sufficient carbon particulates 4 have been deposited, so that a measuring current I_{M} that is registered by the current measuring element 7 can flow between the measuring electrodes 3. The time period that passes from the first usage of the carbon particulate sensor 10 that does not comprise any carbon particulates until the first conductive paths of carbon particulates 4 are formed between the electrodes 3 is also described as the so-called down time of the carbon particulate sensor 10. During the down time the carbon particulate sensor does not provide any measured values for the carbon particulate concentration in the exhaust gas flow 6 and it is therefore important to keep the down time as short as possible. The carbon particulate sensor 10 is ready for use after the situation illustrated in FIG. 5, and said carbon particulate sensor 10 provides a measurement signal that corresponds to the carbon particulate concentration 4 in the exhaust gas flow 6.

In FIG. 6, further carbon particulates 4 have been deposited in the intermediate spaces between the measuring electrodes 3, as a consequence of which the measuring current I_{M} in the current measuring element 7 is increased. In this phase, the measuring current I_{M} in the current measuring element 7 is a signal that is dependent upon the carbon particulate concentration in the exhaust gas flow 6 but it does not necessarily need to be directly proportional to the carbon particulate concentration in the exhaust gas flow 6.

In the situation illustrated in FIG. 7, a maximum measuring current I_{M} flows between the measuring electrodes 3 since the intermediate spaces between the measuring electrodes 3 are completely filled with carbon particulates 4. The maximum measuring current I_{M} has thereby achieved an upper current threshold I_{O} or has even exceeded said upper current threshold. Even if further carbon particulates 4 are subsequently deposited on the interleaved finger electrode structure and as a result deposited between the measuring electrodes 3, the current measuring value at the current measuring element 7 does not increase any further. The carbon particulate sensor 10 is also blind in this situation to the carbon particulate concentration in the exhaust gas flow 6. To restore the carbon particulate sensor 10 to its ready-to-use state, the heating current switch 9 is closed and a heating current I_{H} is directed from the heating current supply 8 to the heating element 2. As a consequence, the carbon particulate sensor 10 heats up to the temperature at which the carbon particulates 4 are burned off and said carbon particulates 4 are then removed as gases 14 that are created during the process of burning off said carbon particulates 4 from the surface of the carbon particulate sensor 10. Since soot comprises primarily carbon, these gases that are generated during the burning-off process are generally carbon monoxide or carbon dioxide. In addition, water that has possibly collected on the surface of the carbon particulate sensor 10 evaporates.

If the carbon particulate sensor 10 is heated to a sufficient temperature, wherein the measuring current I_{M} is monitored and the heating current I_{H} is switched off upon a lower current threshold I_{U} being achieved, then the situation illustrated in FIG. 8 arises. Almost all the carbon particulates 4 are removed from the surface of the carbon particulate sensor 10 by means of the burning-off process. However, a few carbon particulates 4 do also remain on the interleaved finger electrode structure 3 after the burning-off process. The condition illustrated here of the carbon particulate sensor 10 corresponds approximately to the condition illustrated in FIG. 5. With the remaining carbon particulates 4 and the first carbon particulates 4 that have been newly deposited from the exhaust gas flow 6 it is possible by applying the measuring voltage for the carbon particulates 4 to rapidly reorganize to form current paths between the measuring electrodes 3. As a result, the carbon particulate sensor 10 is once again very quickly ready to take measurements and in a quite surprising manner the current characteristic curve 16 of the carbon particulate sensor 10 demonstrates a linearization.

After the situation illustrated in FIG. 5, the carbon particulate sensor 10 once again provides measuring results. The measuring current I_{M} of the carbon particulate sensor 10 is at this stage directly proportional to the carbon particulate concentration in the exhaust gas flow 6 (linearity of the measuring current characteristic curve 16). The time period that elapses from the commencement of the process of burning off the carbon particulates 4 from the surface of the carbon particulate sensor 10 as shown in FIG. 7 until carbon particulates 4 are once again deposited, as shown in FIG. 5, is the down time of the carbon particulate sensor 10 in which no measured values relating to the carbon particulate concentration in the exhaust gas flow 6 are available. However, to be able to monitor the exhaust gas flow 6 with as few interruptions as possible, it is important to keep this down time as short as possible in order to be able to access the measurement signals with as few interruptions as possible. A considerable shortening of the down time is achieved by terminating the burning-off process if the value of the measuring current I_{M} has achieved a lower current threshold I_{U}.

In contrast thereto, when the interleaved finger electrode structure 3 has been completely burned clean, a situation as illustrated in FIG. 3 is reinstated which would be associated with a long phase of reorganizing the current paths of carbon particulates 4 between the measuring electrodes 3. The down time of the carbon particulate sensor 10 is considerably extended by virtue of the interleaved finger electrode structure 3 being completely burned clean.

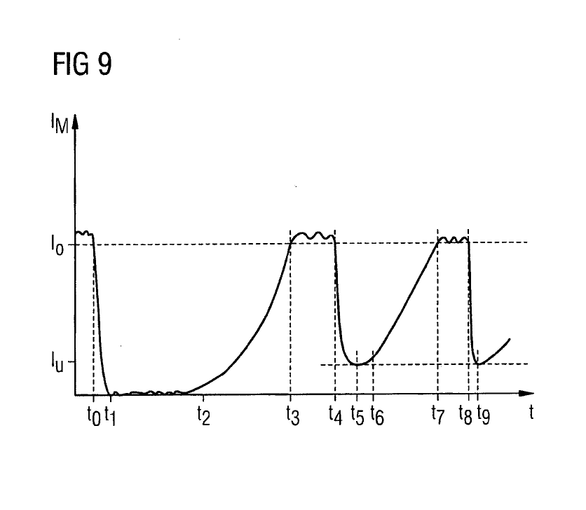

FIG. 9 illustrates the functional relationship between the measuring current I_{M} and the time t, in other words the function I_{M}(t).

The carbon particulate sensor 10 that is fully laden with carbon particulates 4 is burned clean at a zeroth point in time t₀. This occurs by virtue of the fact that the heating current switch 9 is closed and a heating current I_{H} is directed from the heating current supply 8 by way of the heating element 2. It is evident from the high measuring current I_{M}, the value of which is higher than the upper current threshold I_{O}, that the interleaved finger electrode structure 3 is fully loaded with carbon particulates 4. The carbon particulates 4 are completely burned off until the measuring current I_{M} can no longer be measured at the first point in time t₁. The carbon particulates are then completely removed from the interleaved finger electrode structure 3, which corresponds to the condition illustrated in FIG. 3. The current measuring element 7 does not measure any measuring current I_{M} between the first point in time t₁ and a second point in time t₂. Prior to the second point in time t₂, the carbon particulate sensor 10 is blind and by virtue of the process of completely burning clean the interleaved finger electrode structure 3 an extremely long down time arises. This corresponds to the procedure in accordance with the prior art.

After the second point in time t₂, the carbon particulate sensor is once again ready-to-use and can be loaded with carbon particulates 4, wherein the carbon particulate sensor 10 provides a measuring current I_{M} that can be evaluated as an equivalent for the carbon particulate concentration in the exhaust gas flow 6. However, the functional relationship between the measuring current I_{M} and the time t in this case is of a clear quadratic nature. A function of the type I_{M}(t)=a*t², wherein a represents a constant, is therefore produced after the interleaved finger electrode structure 3 has been completely burned clean. The measuring current I_{M} then increases for a period of time until at a third point in time t₃ an upper current threshold I_{O} is achieved. The carbon particulate sensor 10 is at this stage blind and the down time commences.

The process of burning off the carbon particulates from the interleaved finger electrode structure 3 continues until the fourth point in time t₄. However, the measuring current I_{M} is closely monitored and the burning-off process terminated if at a fifth point in time t₅ the measuring current I_{M} has achieved the lower current threshold I_{U}. This corresponds to a situation illustrated in FIG. 8. The carbon particulates 4 that are still remaining on the interleaved finger electrode structure 3 can reorganize themselves into new current paths extremely quickly, whereupon the carbon particulate sensor 10 immediately becomes ready to take measurements again. This is the case approximately at the sixth point in time t₆. The down time of the carbon particulate sensor 10 according to the method in accordance with the invention is considerably shorter than when the burning-off process is performed in accordance with the prior art. In addition, after the sixth point in time t₆ there is a clear linear functional relationship between the measuring current I_{M} and the time t. A function of the type I_{M}(t)=b*t, wherein b represents a further constant, is produced after the controlled process of burning off the carbon particulates 4 from the interleaved finger electrode structure 3 until the lower current threshold I_{U} is achieved.

A considerably simplified form of the signal evaluation is produced from this linear relationship between the measuring current I_{M} and the carbon particulate concentration that develops with the time t on the interleaved electrode structure 3. The measuring current I_{M} increases in a linear manner with the time t between the sixth point in time t₆ and the seventh point in time t₇ until the upper current threshold I_{O} is achieved and the burning-off process restarts at the seventh point in time t₇. The described progression of the function of the measuring current I_{M} from the time t is illustrated with a constant carbon particulate loading for the ideal case of a constant exhaust gas flow 6. In the actual case, the function changes according to the actual exhaust gas flow and the actual carbon particulate loading, wherein the linear characteristics of the sensor signal remain unchanged if the sensor is operated according to the method in accordance with the invention. The burning-off process is performed under constant control of the measuring current I_{M} from the seventh point in time t₇ until the eighth point in time t₈ and upon achieving the lower current threshold I_{U} at the ninth point in time t₉ the burning-off process is again terminated and the carbon particulate sensor is once again ready to take measurements.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-5. (canceled)

6. A method for operating a carbon particulate sensor, wherein the carbon particulate sensor includes an interleaved finger electrode structure upon which carbon particulates from an exhaust gas flow are deposited, the method comprising:
applying a measuring voltage to the interleaved finger electrode structure;
evaluating a measuring current that flows over the carbon particulates and the interleaved finger electrode structure as a measurement of a carbon particulate concentration on the carbon particulate sensor;
burning-off the interleaved finger electrode structure clean if the carbon particulate concentration exceeds a predetermined value by heating the carbon particulate sensor after an upper current threshold value has been achieved;
monitoring the measuring current during the process of burning off the carbon particulates from the interleaved finger electrode structure; and
terminating the burning-off process when a value of the measuring current is lower than a lower current threshold value.

7. The method for operating the carbon particulate sensor as claimed in claim 6, wherein the lower current threshold value is between about 1% and 20% of the upper current threshold value.

8. The method for operating a carbon particulate sensor as claimed in claim 6, further comprising heating an electrical heating element by supplying the electrical heating element with a heating current.

9. The method for operating the carbon particulate sensor as claimed in claim 6, wherein the interleaved finger electrode structure comprises measuring electrodes have a width between 50 and 100 μm.

10. A carbon particulate sensor system comprising:
a carbon particulate sensor including:
a molded body;
a structure of measuring electrodes coupled to the molded body;
a heating element coupled to the molded body configured to burn off carbon particulates from an exhaust gas flow deposited on the structure of measuring electrodes; and
a temperature sensor configured to monitor a temperature of the carbon particulate sensor; and
an evaluation circuit configured to:
apply a measuring voltage to the structure of measuring electrodes;
evaluate a measuring current that flows over the carbon particulates deposited on the structure of measuring electrodes as a measurement of a carbon particulate concentration on the structure of measuring electrodes;
burn the structure of measuring electrodes clean if the carbon particulate concentration exceeds a predetermined value by heating the carbon particulate sensor after an upper current threshold value has been achieved;
monitor the measuring current during the process of burning off the carbon particulates from the structure of measuring electrodes; and
terminating the burning-off process when a value of the measuring current is lower than a lower current threshold value.

11. The method for operating a carbon particulate sensor as claimed in claim 7, further comprising heating an electrical heating element by supplying the electrical heating element with a heating current.

12. The method for operating a carbon particulate sensor as claimed in claim 11, wherein the interleaved finger electrode structure comprises measuring electrodes have a width between 50 and 100 μm.

13. The carbon particulate sensor system as claimed in claim 10, wherein the lower current threshold value is between about 1% and 20% of the upper current threshold value.
